(19) United States
(12) Patent Application Publication
(10) Pub. No.: US 2006/0170924 A1
(43) Pub. Date: Aug. 3, 2006

(54) Optimized standard manual inspection environment for obtaining accurate visible contaminating particle inspection data

(76) Inventors: Gerald Walter Budd, Farmington, MI (US); Julius Z. Knapp, Somerset, NJ (US)

Correspondence Address: Gerald W. Budd, 36853 Heatherton Road, Farmington, MI, 48335, US

(21) Appl. No.: 11/342,986

(22) Filed: Jan. 28, 2006

Related U.S. Application Data
(60) Provisional application No. 60/648,519, filed on Jan. 29, 2005.

(51) Int. Cl. G01N 21/90

(52) U.S. Cl. 356/427

(57) ABSTRACT

A new technology is established by the present invention to assist in the development of more reliable human method for the inspection of pharmaceutical and critical products. The present invention provides the industry with a standardized illumination environment in which the illumination conditions remain constant over extended periods of time. Furthermore, the invention provides the environment in an ergonomic package that is easily adjusted to match physical requirements of individual users without the use of any special tools. The optimized manual inspection environment implements the state of the art control techniques to maintain a constant luminous intensity within an expanded inspection volume. The large inspection volume minimizes the effects of variation in product positions while inspectors perform the operations. The standard environment insures that a constant 550 foot candles is maintained in all manual inspection booths so that inspection results may be compared within the same facility or with facilities located at other sites. A national or international standard for the limiting size of contaminating particles can only be established with the use of standardized manual inspection booth such as presented in this invention.

### CROSS-REFERENCE TO RELATED APPLICATIONS

I claim priority to my Provisional Patent Application No. 60/648,519 with filing date Jan. 29, 2005.

### DESCRIPTION

1. Field of the Invention

This invention relates to the procedures and devices utilized in the optical inspection of transparent containers for the presence of contaminating particulate matter and particularly to inspection of injectable pharmaceutical preparations.

2. Background of the Invention

The inspection for and elimination of visible particle contaminated containers from a batch of injectable pharmaceuticals is a United States Pharmacopeia requirement. This inspection is specified to be, whenever possible, after the product is in its final container. Evaluation that the visible particle incidence rate is within USP acceptance limits for human or veterinary use is an essential part of the injectable batch release procedure. It is also an essential prerequisite to the continuous improvement of the quality of an injectable product batch and to the reduction of product cost. These ends have been achieved by incorporating advances in behavioral science, physics and biophysics, illumination and mechanical engineering, pharmaceutics and statistics into a single analytical structure.

Injectable product batches must satisfy two different USP particle contamination assays prior to acceptance for sale and use. The first of these is a small-scale destructive assay for sub-visible particles. Due to the small sample size of this assay, it is a reliable indicator of problems that exist uniformly throughout the batch. This type of problem is typical of product/container, product/stopper interactions or product formulation and/or product delivery problems. The second of the USP particle contamination assays the 100% visible particle inspection addresses the incidence of random visible contaminating particles. Due to the random nature of these visible particle contaminants, their incidence rate can only be accurately measured and controlled by a 100% inspection of the entire batch.

According to GMP regulations any new method or procedure must be shown to be as good as its predecessor before it can be used on a USP listed product. For visible particulates the preceding visible contaminating particle inspection is that of the single container inspection by clinical personnel at the injection site. This GMP requirement means that any visible particle inspection method or mechanism must be shown to be as effective as the single container inspection for visible contaminants performed by clinical personnel at the inspection site. Accurate evaluation of the capability of a skilled inspector inspecting a single container determines the minimum acceptable performance for any other inspection method or mechanism.

The inspection for visible contaminating particles is a biophysical measurement. To achieve standard sensitivity and statistically accurate data the conditions and implementation of this inspection must be accurately described and reproduced. This includes adjustment of the near vision capability of the inspectors to the normal equivalent of 20/20 vision and adequate training before their use on a USP listed product. The level of light intensity at the inspection point affects particle size detection sensitivity. Another factor, which must be considered, is the decrease in contrast sensitivity with the age of the inspector. This difference can be reduced to negligible dimensions by the choice of the selected light intensity. At 550 ft-candles inspectors up to 65 years old can function accurately. Another factor contributing to the choice of 550 ft-candle illumination intensity is the need to separate visible and sub-visible contaminating particle data. For this need the 550 ft-candle illumination intensity is a convenient choice.

The scientific and statistical methods needed to measure and analyze the incidence of visible particle contamination started to become available during WWII. 1980 saw the first publication of replicable measurements if visible particle contamination expressed as probability of detection.

Data accuracy for visible contaminating particles has been shown to be sensitive to the type and intensity of the light at the inspection point inspection. To eliminate this source of variability from the data, a feedback stabilized 1 cubic foot inspection volume was developed and patented. (U.S. Pat. No. 5,940,176 Aug. 17, 1999). This patent describes the achievement of a volume in space in which the variability of light intensity is maintained within ±5%. This variability is the least discriminable amount that human eyes can detect. Also applicable to this inspection Environment is U.S. Pat. No. 5,940,176 dated Aug. 17, 1999 and other patents pending.

The volume of controlled light intensity has been achieved with the use of two illumination sources, each one describable as an odd function of illumination and distance from the source. In the distance between the two lamps an even function of illumination intensity centered on the midpoint between two opposing sources is achieved. The fluorescent lamps employed are the new extended life lamps with improved color rendition capability excited by ultrasonic electronic ballast. The ultrasonic excitation eliminates the effect of strobed images that occur at a rate twice that of the line voltage.

To assure that the selected light intensity is maintained, feedback controlled light intensity stabilization is employed. Although a one-year decline of intensity of 10% is expected, this system uses direct measurement of the light intensity produced as a feedback control signal. When the measured intensity of the light produced is below the selected value, a red pilot showing ‘end of life’ for the lamp set is turned on and the light sources are shut down. The light intensity stabilization based on direct evaluation of the lamp output is employed; it inherently provides better accuracy than indirect stabilization using measurements of driving current or voltage.

The light intensity at the inspection point, selected on the basis of I.E.S. recommendations is 550 ft-candles ±5%. This value has been selected to minimize the interference fringe between ‘visible’ and ‘sub-visible’ particle sizes. The selection also minimizes the loss of contrast sensitivity with aging. Published data indicates a reduction to negligible magnitude for this effect up to the inspector's nominal age of 65.

The test parameter that has made possible replicable measurements of the incidence of visible contaminating particles is the detection probability of identified sealed containers. Since this measurement uses the probabilistic response of human beings, accurate replicability requires the mean of many responses. Although the basic measurement parameter is probability of detection, a broadly determined calibration curve, which relates particle detection probability to the maximum dimension of a particle, provides a more desirable production control measurement. This conversion also provides a traceable connection between visible particle contamination measurements and the National dimension standards maintained by the National Institute of Science and Technology. Such a dimensionally stable set has been created by the authors for distribution and can be used for creation of the calibration curves.

The accumulation of data from multiple inspection sites collected under well-defined conditions will generate a truly standard national curve, which can assure that visible particle contamination data can precede beyond comparison of results to their correlation. This standard curve will provide an essential transportable standard with which the incidence rate of visible contaminating particles in sealed containers of injectable products can be harmonized.

The detection of visible particles in injectable products is a trainable human skill. As in the performance of any trained human skill, the incidence of fatigue decreases performance effectiveness. Knapp (1980) reported that fatigue could decrease the Reject Zone Efficiency of an inspector by as much as 30%. When the movements required of an inspector do not consider the physical size of the inspector, the duration of work time before the onset of inspector fatigue can vary widely. An efficient manual inspection requires normalization of the physical movements of each inspector.

The invention described here is called a Manual Inspection Booth or MIB. The MIB can be configured in several ways to best meet the requirements of the desired inspection use. The MIB series of standard manual inspection environments for accurate visible contaminating particle inspection data, shown in FIG. 1, contains a 1 cubic foot volume in which the delivered light intensity, following IES recommendations, is 550 foot-candles ±5%. In this inspection environment all motions are scaled to the physical dimensions of the inspector. The individual parts of this inspection booth are adjustable, tool free, to match the inspector's height and reach as described in the following sequence of actions for a production inspection. The use of the inspection procedure, outlined in the section “Sequence of Inspection Motion” below, by a well-trained inspector results in a smooth flow of inspected containers using tactile location and placement of containers. The work output of the inspector is optimized: all the inspection motions are scaled to the physical size of the inspector thus normalizing the effects of fatigue.

Combining NIST traceable sizing of stable microspheres with statistically accurate determinations of their rejection probability has made possible realization of a calibration curve relating the probability of manually detecting a contaminating particle to its NIST traceable maximum physical size. With USP acceptance and use of this calibration curve, inspection sensitivity and discrimination can both be defined and securely evaluated. This means that the basic manual inspection at all producing sites, and therefore the validated capability of any contaminating particle inspection method or mechanism, can now be evaluated on a level playing field. The availability of secure statistically reproducible contaminating particle data makes possible the on-going cycle of parenteral production line process improvements envisioned in PAT publications.

### BRIEF SUMMARY OF THE INVENTION

It is an object of the present invention to transform the present non-standardized inspection procedure implemented in the majority of pharmaceutical contamination inspection environments into a controlled and reproducible manual inspection environment that will yield accurate and repeatable results.

It is a further object of the present invention to provide a well controlled and uniform illumination within the manual inspection environment.

It is a further object of the present invention to provide an optical feedback mechanism to insure that the illumination level within the inspection volume remains constant while in operation.

It is a further object of the present invention to provide an optical feedback mechanism that will maintain a constant luminous flux in the inspection volume for long periods of time, greater than 6 months of continuous use.

It is a further object of the present invention to provide a structure by which to achieve the controlled and uniform illumination volume within the manual inspection environment.

It is a further object of the present invention to provide a large well-defined volume for the position of sample containers that will enhance the detection of contaminating particle(s).

It is a further object of the present invention to provide a method to reduce operator fatigue while performing the operations within the defined inspection volume.

It is a further object of the present invention to allow adjustment by individual operators to minimize the effects of fatigue without the use of special tools.

It is a further object of the present invention to provide a modular fabrication technique that will allow modification to the size of the environment while maintaining the desired luminous flux within the inspection volume.

It is a further object of the present invention to provide a method to orient the illumination sources in either a horizontal or vertical attitude for operation.

A short description of the mechanical and optical equipment as used in the inspection device is provided here. The present invention describes a method to generate a large inspection volume wherein the container may be positioned and the illumination conditions will remain substantially the same intensity providing for a more accurate detection of contaminating particles in the solution.

The method comprises the steps of:
a) pre-positioning particles in the container whereby placement of the container on an inclined shelf causes substantially all of the particles in the injectable solution in the container to settle at the lowest point in the container;
b) the container is retrieved from the in feed tray, usually working from top to bottom, and positioned within the inspection volume by the operator;
c) the in feed (containers to be inspected) tray and disposition (inspected containers) trays are adjusted for height, angle, rotation and placement so as to reduce the physical strain of the inspector;
d) the illumination source is switched on and allowed to stabilize for at least 5 minutes prior to use;
e) the invention implements photo-resistors or photo-diodes positioned with an unobstructed view of the illumination sources (typically fluorescent tube lamps) that provide a voltage signal that proportional to the luminous flux and this signal is used in a closed loop feedback circuit to maintain a constant light output;
f) a parallel lamp configuration with sources positioned on each side of the inspection volume increases the volume in which the light intensity in nearly constant;
g) the uniformity of illumination within the inspection volume permits the inspector to perform the inspection anywhere the inspection volume;
h) the contents of the container are placed in motion by imparting a circular wrist movement;
i) the contaminating particles are differentiated from the background by the direct observation of their motion in solution;
j) the background for the inspection can be white, black or a standard photographic 18% grey card may be implemented;
k) white or light colored particles are readily found using the black background, black or dark colored particles are readily found using the white background or the 18% grey card background can be used for isolating particles of all colors other than those with a contrast approaching 18% grey;
l) each container is inspected for a specified length of time, the duration of the inspection is paced by the PLC timer;
m) a separate timer is available for light, dark and 18% gray card inspections;
n) the inspector registers the disposition of the product after each inspection by depressing a key pad or touch screen interface of the PLC or micro-computer.

These and other objects, features and advantages of the present invention will become more evident from the following discussion and drawings in which:

### BRIEF DESCRIPTION OF THE SEVERAL VIEWS OF THE DRAWINGS

FIG. 1 illustrates the Manual Inspection Booth (MIB-100) with major components necessary to the invention to function and their relative position with respect to each other;

FIG. 2 illustrates the MIB-100 Light Box Operator Interface Module;

FIG. 3 illustrates the side or end view of the MIB-100 framework.

### DETAILED DESCRIPTION OF THE INVENTION

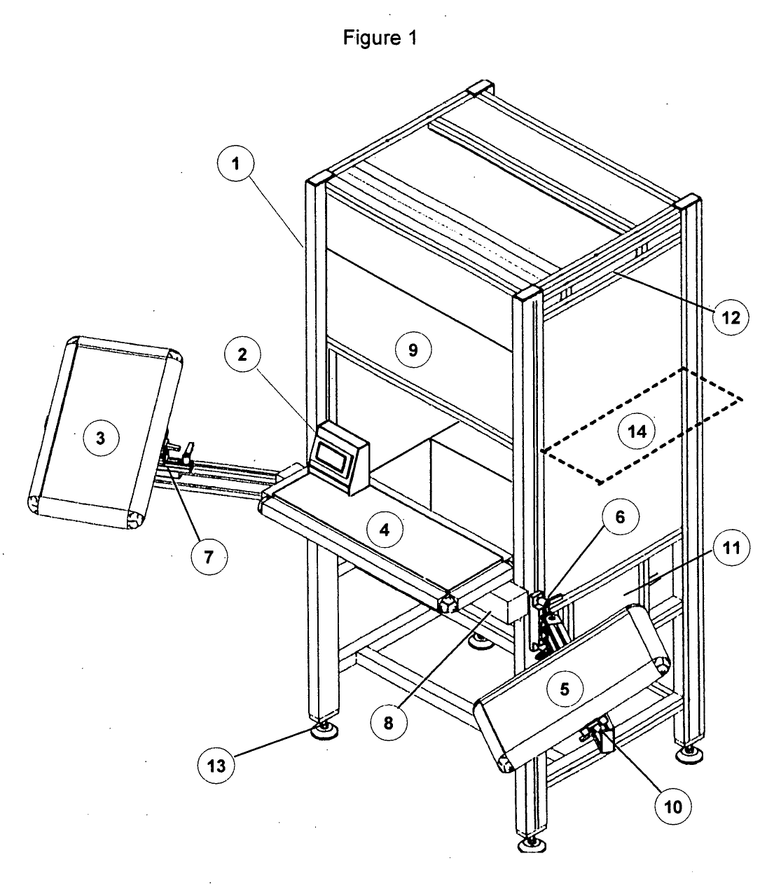

FIG. 1 represents the essentially complete apparatus in the form that would be used for inspection. The main framework provides support for the major components, shrouds the inspection area from ambient lighting and serves to provide ergonomic conditions to reduce fatigue of the inspector. Item 1 is the system framework and can be constructed of several materials with extruded anodized aluminum being preferred. The aluminum extrusion may be formed with channels to allow for the easy adjustment of attachments and optional components. Item 2 represents the operator interface, which is used to control the inspection duration, and to record/display the results of the inspection process. Item 2 is a small touch screen interface that changes color depending on the operation sequence. It is connected to a programmable logic controller (PLC) that serves to monitor system functions and operation. The PLC can be replaced with a micro controller or microprocessor running a more sophisticated operating system to perform more advanced statistical task. We refer to this more advanced version as an MIB-200 with a larger flat panel touch screen display on a movable positioning arm. The design of the invention allows Item 2 to be moved to either the left or right-hand side of the Item 4 the adjustable armrest. This allows for maximum ergonomic efficiency for either right or left-handed inspector.

Item 3 and Item 5 are used as source (in feed) or disposition (discharge) tray holders. The configuration will depend on the dominant hand of the inspector. A right-handed inspector would normally acquire a new test sample from a tray held by Item 5 shelf. Move the sample to the inspection booth by holding it in the right hand, agitating the sample for inspection with the right hand and then transferring it to the left hand for disposition into a tray positioned on item 3 shelf in it is “acceptable quality”. The left hand will then depress the proper button on the operator interface (Item 2) before retrieving the next sample for testing. Item 3 and Item 5 have similar construction and adjustment capabilities. Item 3 and 5 may be raised or lowered vertically by loosening the level on Item 6. Item 6 is a block that holds a horizontal rail on which the item 3 and 5 are attached. No tools are required for this adjustment. Item 6 provides a hand level that can be tightened or loosened by the hand of the operator and provides sufficient holding force to support the arm and tray assembly with product of more than 100 pounds.

Item 7 is a combination slide/pivot bracket that allows the shelf to move along the horizontal rail support off Item 6. The Item 7 sub-assembly also allows the shelf to tilt about the pivot point. This allows the operator to tilt the plane of the shelf toward or away from them. Again this item requires no tools for adjustment and can be loosened or tightened with a simple turn of the handle.

The shelves (Item 3 and Item 5) can also be adjusted so that the plane of the shelves can be moved closer or further away from the operator with the aid of Item 10. There are four sliding brackets (Item 10), two on each of the shelves extreme rails. Each has a hand level and allows the shelves to slide in a direction perpendicular to the large horizontal rail supported by Item 6 on either side of the main enclosure.

A horizontal support rail (Item 8) supports the armrest (Item 4). The armrest is constructed such that it can be moved vertically by loosening a pair of hand levers that allow Item 8 to move up or down along the front vertical rails of the MIB. That is a additional pair of hand levers on the lower surface of Item 8 that allow the arm rest (Item 4) to be moved in or out of the inspection chamber. The armrest has a pad filled with closed cell foam to relieve the pressure on the operator's elbow. The pad can be reversed for right or left hand operation. This vertical and horizontal adjustment of the arm rest in critical to allow the inspector to position the sample in the volume of uniform illumination within the inspection booth. The adjustments are made so that the extension of the operator forearm into the center of the inspection volume minimizing physical stress thus reducing operator fatigue and increasing inspection efficiency.

Item 9 is the adjustable front shroud on the inspection booth. The shroud may be adjusted up or down to accommodate the sitting height of the inspector. The shroud is used to minimize the amount of extraneous ambient light from entering the inspection chamber. A tall inspector may have to raise the shroud in order to prevent optical interference with the line of sight to the sample. A shorter inspector may have to lower the shroud to prevent interference from ambient light sources. The front shroud is constructed to two parallel planes of material that can slide parallel to each other to increase or decrease the upper area on front of the inspection booth.

Items 11 and 12 represent the lower and upper illumination sources respectively. Each illumination source is designed to accommodate two to four lamps. Each lamp is of the proper luminous flux to provide the desired candlepower in the inspection volume. The lamps are positioned with the equivalent displacements above and below the centerline of the inspection volume. The centerline of the inspection volume is determined by the eye-level of the average inspector. The lamps are positioned properly on mounting diffuse reflecting mounting plates. The spacing of the lamps is such that each lamp or section of lamp is placed on a pitch of two lamp diameters. The lamps are positioned such that 550 foot-candles is available in the inspection volume of approximately 1 cubic foot. The useful volume of the inspection booth is dependent on the length of the lamps used. A wider inspection volume can be achieved by using longer lamps. The MIB is available in several configurations, the standard version uses lamps approximately 23 inches in length, and the extended version uses lamps that are 33 inches in length. Theoretically the MIB can be configured to accommodate a variety of inspection volumes as long as the 550 foot-candle lamp intensity is achieved. The MIB uses very high frequency electronic ballast for driving the lamps. It is best that the driving frequency is greater than 20 kHz to provide optimum inspection results. The design requires a closed loop feedback between the lamps and the electronic ballast to maintain constant luminous flux in the inspection volume. This is achieved using photosensitive devices to continuously observe the luminous flux of the lamps and adjust the current to maintain the desired level. The purpose of the Manual Inspection Booth is to provide a standard inspection environment and therefore the uniformity of the illumination inside the inspection volume is critical. This is a major benefit of the described invention in that it is capable of providing constant light output over long periods of time.

Item 13 are the leveling feet for the MIB and allow the structure to be used on non-level plant floors. The leveling feet should be adjusted so that the inspection booth does not move when the inspector goes through the motions during the inspection process. It also provides an adjustment method to correlate the center of the inspection zone with the eye-level of the operator.

Item 14 provides an optional printer shelf if the upgraded MIB-200 version with microprocessor is selected.

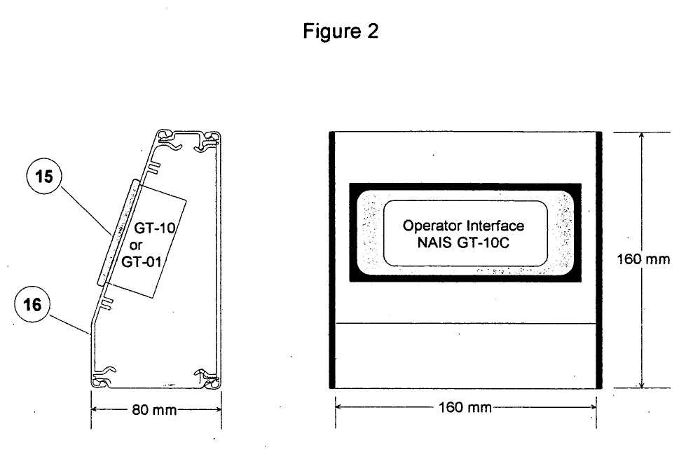

FIG. 2 represent the general characteristics of the operator interface used on the MIB-100 inspection booth. The simple housing (Item 16) is constructed of either stainless steel or anodized aluminum extrusion. The front surface is beveled backward to make viewing the touch screen display (Item 15) easier. The short vertical section on the front of the operator interface is concealed below the level of the arm rest pad. The touch screen display is provides the ability to display messages with different color backgrounds. The color of the display background represents the type of operation that is being performed. Green normally indicates a setup or inquiry function; Orange and Red normally represent an inspection function. The small housing can be positioned on either the right or left hand side of the armrest. A small cable is attached to back of the housing and provides communication with the PLC or microprocessor.

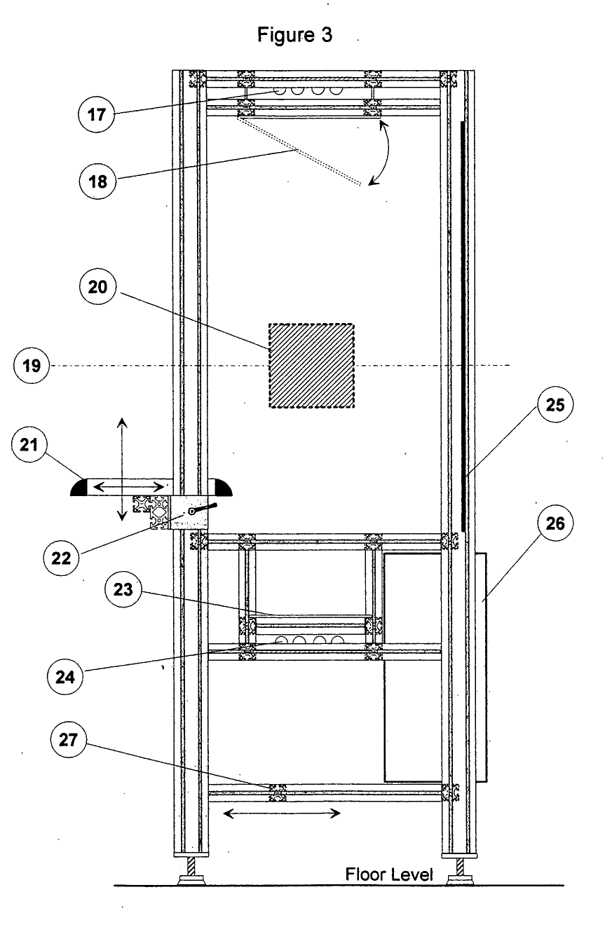

FIG. 3 represents a section view through the side of the MIB-100. The purpose of this figure is to illustrate the relative position of components with respect to each other. Visible in FIG. 3 is the overall framework of the inspection booth and several of the key features. Item 17 represents the top illumination source; this illustration shows four lamps centered in a small chamber at the top of the inspection booth. Item 18 is the top diffuser for the top illumination source. The top diffuser is constructed of frosted polycarbonate sheet material. The top illumination source is totally enclosed in a small chamber. This is critical to maintain a consistent temperature around the lamps. The lamps are fluorescent and may be influenced by temperature fluctuations. Sealing them in a small enclosure prevent air currents from affecting the output of the lamps. This instrument is designed to provide very stable illumination conditions over an extended period of time. All precautions are taken to insure the stability of the instrument and this is a critical feature. The lamps are mounted on a metal plate with a diffuse reflective surface and the sides of the chamber are coated with a diffuse reflective material to enhance the uniformity of the light. Item 18 has hinges mounted along one edge to allow the panel to swing down. The panel is opened by removing two thumbscrews on the opposite edge that hold it up in place. This arrangement permits easy access to the chamber for lamp replacement. The polycarbonate diffuser also provides an added level of safety in case of a lamp failure or breakage. Falling debris will not contaminate the product being inspected.

The line represented by Item 19 is the centerline of the inspection booth at eye-level of the inspector. The inspector is seated on an adjustable chair so that eye-level corresponds to the centerline on the inspection booth. A line is drawn on one side of the inspection booth interior wall to indicate the centerline of the inspection booth. Item 20 represents the cross-section of the allowable inspection volume in the center of the inspection booth. The depth of the inspection volume can be approximated from the front of the first lamp to the back of the last lamp. The height of the inspection volume is roughly equal to the depth and its width is half the length of the lamps and centered. The measured inspection volume is approximately 1 cubic foot in size and centered vertically between the upper and lower lamps. This is reference in an earlier patent. The MIB provides a consistent method of creating the uniform inspection volume. This device can be duplicated many times achieving the same inspection volume and illumination intensity. This is critical for the creation of “standard” test environment so that inspections can be performed in a reliable manner.

Item 21 represents the armrest and illustrates the range of motion that can be achieved. The shelf can be move in or out of the inspection chamber. With the aid of Item 22 the armrest can be raised or lowered to accommodate the length of the inspector's forearm to coincide with the centerline of the inspection volume when extended inside the MIB. One of the primary design parameters for the MIB is make the inspector as comfortable as possible when performing the inspection task. The inspection efficiency can be directly correlated to the fatigue level on the inspector.

Item 23 and 24 represents the lower diffuser panel and illumination source and is similar to Items 17 and 18 discussed above. The inspector is prohibited from directly viewing the lower diffuser panel when inspecting by having its position inside of a well. The lower diffusing panel (Item 23) does not require a hinged edge because the panel is supported on four sides. Thumbscrews are used to secure the panel in place.

Item 25 represent the inner liner of the inspection booth. A separate removable liner is used to darken the inside of the inspection chamber. The liner is constructed of a 6 mm thick polycarbonate sheet with a coated surface. The surface is a special photographic black matte finish or lint free velvet with adhesive backing. The panels are made completely smooth with no wrinkles or distinguishing features that will interrupt the smooth background in the inspector's view. The panels are made removable so that they can be taken out of the inspection area (clean room) and cleaned outside reducing potential contamination in the facility. The panels are mounted on three sides of the MIB interior. All other surfaces in the interior of the inspection booth are of diffuse black matte material to reduce glare. The design of the inspection calls for either a one or two step inspection procedure. The one step procedure utilizes an 18% grayscale card placed directly along the centerline of the inspection volume so that the sample can be viewed with the card in the background for a specified duration. The two step inspection procedure calls for an inspection using a black background followed by an inspection using a white background for a specified duration. The inspection chamber is divided in half and a white card is placed so that its right edge is aligned with a line that divides the chamber in half vertically. The design incorporates a mechanical sheet holder so that the user may select either method and insert the appropriate background.

Item 26 represents the main electrical enclosure and it is mounted on the rear of the inspection booth. The electrical enclosure is used to house the electronic ballast(s), PLC or microprocessor, and power distribution.

Item 27 represents the adjustable foot rest support. The adjustable foot rest support can be move toward or away from the inspector. The support allows several different footrest configurations to be positioned at the desired tilt angle for the inspector.

Detailed Sequence of Inspection Motions
1) The seated eye height of the inspector to the center line of the controlled illumination volume as shown on the Booth
2) The center of both trays is adjusted to equal the elbow height of the seated inspector.
3) The 3 dimensional inclination and position of each tray is selected to provide full access to the contents of the tray by the movements of the inspector's wrist and forearm only.
4) Before inspections commence, the inspector enters the complete identification for the inspection. This includes the inspectors ID, date, time, product and potency and the quantity to be inspected. Following review and approval by the supervisor, the control panel is Green and control reverts to the inspector.
5) The inspectors right arm is used to select a container from the right tray, the un-inspected container tray, and to bring it to the first of two inspect positions, the white background position.
6) At the inspect position, the inspectors forearm rests on the padded support whose position is adjusted to support the forearm when the container is positioned at the height center of the accurately illuminated test volume. The width of the forearm rest provides support during both the white and black background inspections. NOTE: The padded rest is positioned so that the forearm is supported with the container to be inspected positioned at the center height of the illuminated volume.
7) At the end of the container positioning motion, the container is agitated in a conic motion ending with the maximum deceleration to a final stop.
The inspector is trained to achieve maximum deceleration below that at which cavitation bubbles appear as a condition for a good inspection.
8) The end of the white background inspection is signaled to the inspector when the face of the signal panel turns red.
9) The inspector has three action choices at the end of the white inspection period: Accept, Reject and third No decision, repeat cycle.
10) In the event a White Background Reject decision has been made, the inspected container is transferred to the left hand for disposition in the Reject Tray and the next container is selected by the right hand and transferred to the inspect position and steps 6-9 are repeated.
11) Following a white background Accept decision, the inspector moves the container position by the width of the white background to a black position and initiates the black background inspection as in Steps 6 through 9 with a Green Panel display.
12) At the end of the black background inspection period, the panel is red and the inspector again makes one of three decisions: Accept, Reject or no decision, Repeat cycle. In the event a Black Background Accept or Reject decision has been made, the inspected container is transferred to the left hand for disposition in either the Accept or Reject Tray and the next container is selected by the right hand and transferred to the inspect position for the White background Inspection and steps 6-9 are repeated.

For test group validation demonstrations an XY bar code reader and the provided software furnish convenient data handling and final results.

Inspector Evaluation Procedure

Evaluation of the effectiveness of an inspector or a group of inspectors can be made with a serial numbered test group of 248 containers. This test group should be broadly representative of the entire visible particle contamination spectrum from absolutely clean to those containers with grossly contaminated ‘must reject ’ visible particles. The ‘must reject’ group is the group of containers whose individual rejection probability is equal to 0.7071 or greater. To assure production line equivalent inspections, this ‘must reject’ group is restricted to 62 containers, 25% of the total number of containers in the test group.

The test containers can be selected in a preliminary test using the pooled inspection results of a group of 5 experienced inspectors who inspect once each 400 randomly selected containers from current production and 100 containers from the retained reject library. The containers in the test group are selected on the basis of the total number of rejections from the pooled results of all inspectors. 62 of the containers are from the group that has not been rejected in any inspection, 62 containers are selected from the test group of containers that have been rejected once. The next 62 are selected from the containers that have been rejected 2 or 3 times in the five inspections. The last group of 62 containers is selected from thee group that have been rejected 4 or 5 times in the initial screening inspection. Incorporation of the calibration group of NIST traceably dimensioned stainless steel microspheres provides the means with which the sensitivity of the inspection can be checked against the proposed National Standard.

A sequence of 10 inspections per inspector provides adequately sensitive test results. An EXCEL analysis of the inspection data has been used effectively for this purpose. When an EXCEL is used, line numbers can represent each container. Representing accept signals by zero and reject signals by 1 makes it possible to us row additions to calculate the total number of rejects per container for an inspector or for the entire inspection group. The experimental rejection probability is calculated as the total number of rejections per container divided by the total number of inspections per container.

The number of containers in the Accept and Gray Zones is determined by the number of containers in the test group whose rejection probability is less than 0.7071. The number of containers in the Reject Zone is equal to the number of containers whose rejection probability is equal to or greater than 0.7071.

The effectiveness of an inspector or a group of inspectors is determined by the Reject Zone Efficiency, the RZE. RZE is calculated as the sum of the rejection probability of each Reject Zone container divided by the number of containers in the Reject Zone. A Reject Zone Efficiency equal to or greater than 0.85 should be obtained.

Similarly, the False Reject Rate is calculated as the sum of the rejection probability for each container in the Accept and Reject Zones divided by the total number of containers determined to be in these zones. An upper limit of 0.10 should be obtained for this reject loaded group.

The procedure described above requires manual entry of the serial number of each container in each inspection to assure secure correlation of container number and inspection results. Where such an evaluation is planned to be used as a both a periodic re-certification procedure and a means to evaluate new hires, a more automated alternative should be considered. The MIB 100A control uses a PC and has the design capacity to include an x-y bar code label reader to associate the inspection of the container with its identity. It is also shipped with the software to store and analyze inspector evaluation data using Knapp's analysis and to compare inspection results of inspected batches.

Sequence Control and Data Recording

The following information describes control of the inspection sequence, data recording and data transfer of the MIB-100 Manual Inspection Booth.

Step 1: Turn-On

Power up the PLC by depressing the push button on the left side of the display panel. The first screen to appear when initializing the PLC is the Title Screen. After approximately 20 seconds an orange screen will appear instructing the operator to wait 5 minutes for the lights to warm.

Step 2: Starting Check

A red flashing “Lamp out of regulation” screen indicates a bad lamp(s). Turn the power off and replace the lamps in pairs (either the top two lamps or the bottom two lamps).

Step 3: Main Screen

The following screen is the Main Menu. This menu allows the operator to alter the settings, initialize inspections and obtain results from those inspections.

Step 4: Set-Up Menu

By selecting the Settings button from the Main Menu the Set-Up Menu will appear. From here the operator can select the type of inspection to be performed, change the time of the inspection and turn off the lights to restart the system.

4.1 Select Inspection Type to choose either Light/Dark Inspection or Gray Card Inspection.

4.2 Assign rejection categories to the numeric keypad

Step 5: Timer Settings

Select Timer Settings to change the actual time of the inspection. Touch the number to the right of the three timer options to select the time desired. All time intervals are in 1/10 seconds. For example, by selecting “50” your inspection time will be 5 seconds. After choosing the time select the arrow button to enter. Select the CLR button to start over and re-enter time.

Step 6: Operating Start White/Black Inspection Sequence

When the proper settings are complete select START to begin the inspection.

If Light/Dark Inspection is selected the light background will be tested first and then the dark background. While testing the display will countdown the test time selected. After the light background inspection, the dark background inspection screen will automatically appear. The operator can opt to start the dark inspection or retest the light background, if needed. If a defect was detected on the light background select Light Defect and the system will automatically bypass the dark inspection and return to the light test to continue. If no defect was found in the light test start the dark inspection. When complete the Provide Judgment screen will appear prompting the operator to select “Good” or “Bad.” A retest of the dark inspection may be selected at this point, also. After indicating whether a defect was found or was not found the system will return to light test mode.

Step 7: Operating Start Single 18% Gray Background

If Gray Card Inspection is selected the Provide Judgment screen will automatically appear after each testing.

Step 8: Shift End Report

Note that at any time during the testing you may check the status of the results by selecting the Main Menu button.

When testing is complete return to the Main Menu to review the results.

Select main screen to initiate manual or print report.

The Results screen will provide the operator with the total of “good” and “bad” and totals in each defect category listed. Record results or, select Reset to print out and clear the current count categories.

The ability to consistently detect known size particles in the inspection volume provides a method that makes NIST traceable maximum particle size measurements possible with the generation of a calibration curve relating the probability of detecting a particle to its physical size. When this calibration curve is determined with microspheres that have been inspected under standard conditions (light quality and intensity, manipulation of the container, duration of the inspection, the background employed) and sized with NIST traceability, the basis for an accurate international standard of particle contamination quality has been established.

The standard (particle size)/(particle rejection probability) calibration curve can be considered an equivalent to the use of the set of standard microspheres used to calibrate particle counters. The probability that similar microspheres will be found in a biological or chemical suspension is small. The microspheres in the calibration sample are used to determine that the functionality of the visible particle inspection method or system has the sizing accuracy desired.

The U.S.P. designates the effectiveness of the manual inspection, which is available up to the moment of clinical use, as the benchmark inspection performance required. Any alternative inspection must be shown to be as effective as the benchmark manual inspection before it can be used on a U.S.P. listed product. The improvement described in the present invention applies to both the benchmark manual inspection as well as to semi- and fully automated contaminating particle inspection methods and mechanisms described herein.

What is claimed is:

1. A method and apparatus that is capable of producing a large volume of uniform and consistent illumination for the manual inspection of pharmaceutical or other products therefore, said method comprising the steps of:
(a) design of apparatus accommodates multiple sizes of illumination sources;
(b) the illumination sources implement a photo-sensitive device, such as photo-resistor or photo-diode as part of a closed loop feedback mechanism to monitor the luminous flux of the source at a high frequency (>5 KHz) and then adjust the output so as to maintain a nearly constant luminous intensity within the inspection volume;
(c) the use of parallel illumination sources arranged on opposite sides of the inspection region so that the illumination in the inspection volume is additive and produces nearly uniform in intensity within the inspection volume;
characterized in that the additive intensity of the present invention varies by less than 5 percent within the inspection volume.

2. An ergonomic design and method of fabrication for apparatus that allows adjustment of major components without the use of tools therefor, said method comprising the steps of:
(a) generation of framework using extrusion profile (metal or plastic);
(b) the length of extrusion profile components can be easily changed to accommodate different length illumination sources;
(c) channels of extrusion profile can be uses for controlled movement of major components, like shelves and armrest; to best match the posture of individual inspectors.
characterized in that each individual inspector will adjust the major components to “best fit” their method of performing the inspection task.

3. A method and apparatus for control of the inspection system illumination, duration of inspections, and the logging of inspection data using an electronic device with interactive menus as characterized with the use of a programmable logic controller (PLC) or micro-computer.

4. The method of claim 1, wherein the present invention can adjust the luminous intensity within the inspection volume between 250 and 600 foot candles.

5. The method of claim 1, wherein the present invention provides a large volume, approximately 15-20 liters, in which the luminous intensity is maintained and inspection of product can be performed.

6. The method of claim 1, wherein the use of high frequency (>20 KHz) power supplies for the illumination sources reduce the fatigue of human inspectors by elimination of lighting strobe effects (beat frequency associated with standard 60 Hz ballast).

7. The method of claim 1, wherein the apparatus will prohibit the use of expired or poor condition illumination sources as they approach the end of their service life by not being able to keep power supplies within acceptable operating parameters and indicating to the operator with a visual warning (indicator lamp or symbol on operator interface panel).

8. The method of claim 1, wherein the volume of the inspection zone can be easily altered by selecting the proper length illumination sources.

9. The method of claim 2, wherein the centerline of the inspection volume may be changed by altering the position of the illumination sources and the height of the arm rest.

10. The method of claim 2, wherein the apparatus can accommodate different size (height and width) inspectors by adjusting the location, height, angle, rotation and tilt of the in feed and disposition shelves.

11. The method of claim 2, wherein the design of the apparatus provides for ergonomic motion between the in feed, inspection and disposition stations which help reduce operator fatigue.

12. The method of claims 1 & 2, wherein the illumination sources can be easily changed (physically and electronically) and the system will produce the desired luminous intensity within the inspection volume after source replacement.

13. The method of claim 2, wherein the imposition of a tilt on the in feed tray will preposition heavy contamination particles in the heel of the containers and thus improve the probability of detection.

14. The method of claim 3, wherein the invention can insure the proper inspection sequence and allow the supervisor a simple method of changing inspection sequences.

15. The method of claim 3, wherein the invention is capable of allowing the user to select inspection durations and keep the inspectors on pace using audio/video indicators.

16. The method of claim 15, wherein it is inherit in the method that each inspector in a group of inspectors using the present invention will have consistent time times before judgment of product quality.

17. The method of claim 3, wherein the results of each inspection will be tallied at its conclusion and the invention can be used to reconcile the Accept/Reject product count at the end of each batch.

18. The method of claim 3, wherein the more sophisticated microcomputer is implemented the invention will be capable of defect type classification to determine significant sources of contamination in product batches.

19. The method of claim 3, wherein the more sophisticated microcomputer is implemented in conjunction with an electronic code reader (bar code or 2-D matrix code) the invention it is capable of scanning “test” samples prior to inspector testing to determine the size limit of contaminating particles that individual inspectors can detect.
